(19) United States
(12) Patent Application Publication
(10) Pub. No.: US 2009/0327329 A1
(43) Pub. Date: Dec. 31, 2009

(54) PRICE ESTIMATION OF OVERLAPPING KEYWORDS

(75) Inventor: Tchavdar Dangaltchev, Bellevue, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/163,783

(22) Filed: Jun. 27, 2008

(51) Int. Cl. G06F 17/30; G06Q 30/00

(52) U.S. Cl. 707/102; 705/400; 707/E17.045

(57) ABSTRACT

In this invention, systems and methods for providing a price estimate for two or more keywords are provided. More specifically, a price estimate is determined and provided when each keyword has terms in common, where each keyword includes one or more terms. For example, a first keyword (e.g., “car”) and a second keyword (e.g., “new car”) share a common word. Thus, the price estimate of these keywords will factor in the commonality between the keywords and provide a more accurate price estimate to the advertiser, when bidding on the keywords. A more accurate price estimate allows the advertiser to better estimate their advertising budget when factoring in the overlapping keyword traffic, and accordingly, bid on more keywords.

### BACKGROUND

Typically, when an advertiser bids on various keywords, some of the words comprising those keywords may overlap. Such an overlap affects the price estimation given to the advertiser by the publisher. That is, the price estimate provided to the advertiser will be higher than the actual monetization value when there are multiple keywords that an advertiser wishes to bid on. Providing a more accurate price estimation, particularly when an advertiser has more than one keyword on which they want to bid, allows the advertiser to potentially bid on more keywords, which in turn benefits the publisher.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with embodiments of the present invention, systems and methods for providing a price estimate for two or more keywords are provided. More specifically, a price estimate is determined and provided when each keyword has terms in common, where each keyword includes one or more terms. For example, a first keyword (e.g., “car”) and a second keyword (e.g., “new car”) share a common word. Thus, the price estimate of these keywords will factor in the commonality between the keywords and provide a more accurate price estimate to the advertiser, when bidding on the keywords. A more accurate price estimate allows the advertiser to better estimate their advertising budget when factoring in the overlapping keyword traffic, and accordingly, bid on more keywords.

### BRIEF DESCRIPTION OF THE DRAWINGS

The present invention is described in detail below with reference to the attached drawing figures, wherein:

FIG. 1 is a block diagram of a computing system environment suitable for use in implementing embodiments of the present invention;

FIG. 2 is a block diagram illustrating an overview of a system in accordance with an embodiment of the invention; and

FIG. 3 is a flow diagram illustrating a method for providing a price estimate for two or more keywords, in accordance with an embodiment of the invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

In accordance with embodiments of the present invention, systems and methods for are provided. In this invention, systems and methods for providing a price estimate for two or more keywords are provided. More specifically, a price estimate is determined and provided when each keyword has terms in common, where each keyword includes one or more terms. For example, a first keyword (e.g., “car”) and a second keyword (e.g., “new car”) share a common word. Thus, the price estimate of these keywords will factor in the commonality between the keywords and provide a more accurate price estimate to the advertiser, when bidding on the keywords. A more accurate price estimate allows the advertiser to better estimate their advertising budget when factoring in the overlapping keyword traffic, and accordingly, bid on more keywords.

In accordance with one embodiment of the present invention, one or more computer storage medium with computer-executable instructions embodied thereon for performing a method for providing a price estimate for two or more keywords, where the two or more keywords comprise the same match type, each keyword comprises one or more terms, and where a first keyword comprises at least part of the terms of a second keyword. The method comprises, in part, determining the price estimate of each keyword; creating a first table, where the first table includes a value for impressions for each keyword and a value for the number of terms in the keyword; calculating a value for impressions of each keyword; entering the value for impressions in the first table; creating a second table that includes rows for a first and second keyword; determining each first keyword that matches the second keyword; deleting a row in the second table, wherein the row includes a matching first and second keyword; and calculating a value for new impressions for each keyword, using the first and second table.

Having briefly described an overview of embodiments of the present invention, an exemplary operating environment suitable for use in implementing embodiments of the present invention is described below.

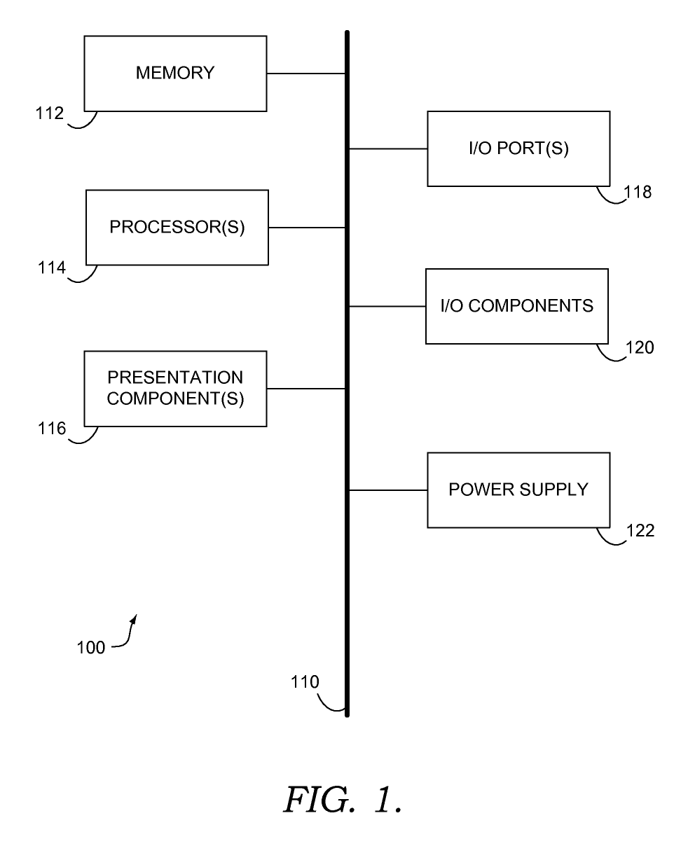

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the illustrated computing environment be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the present invention may be practiced in a variety of system configurations, including hand-held devices, consumer electronics, general-purpose computers, specialty-computing devices, and the like. Embodiments of the present invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disk drives, and the like. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game advertisement, satellite dish, scanner, printer, wireless device, and the like.

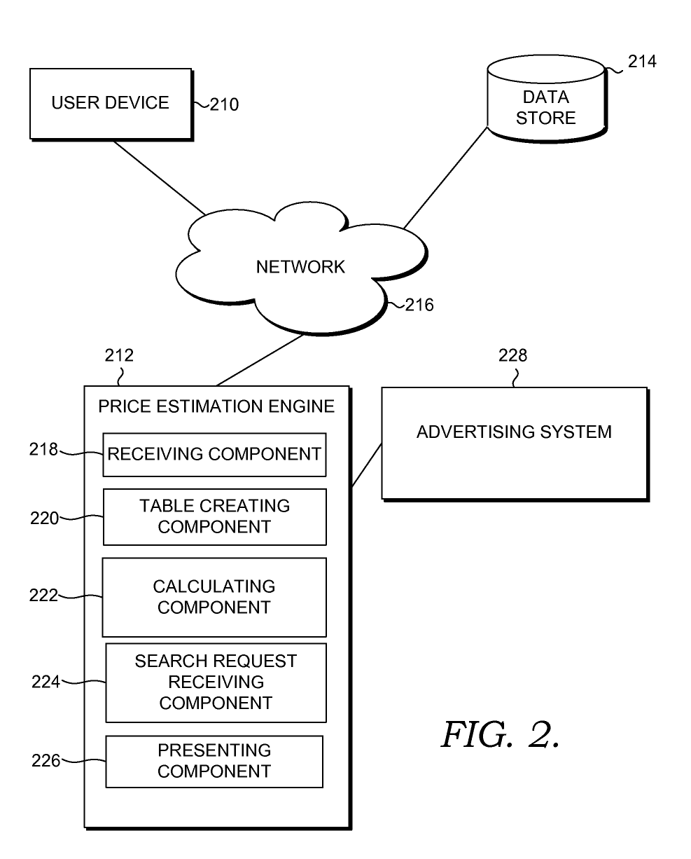

Turning now to FIG. 2, a block diagram is illustrated that shows an exemplary computing system 200 configured to provide a price estimate of two or more keywords, in accordance with an embodiment of the present invention. It will be understood and appreciated by those of ordinary skill in the art that the computing system 200 shown in FIG. 2 is merely an example of one suitable computing environment and is not intended to suggest any limitation as to the scope of use or functionality of the present invention. Neither should the computing system 200 be interpreted as having any dependency or requirement related to any single component/module or combination of components/modules illustrated therein.

Computing system 200 includes a price estimation engine 212, a user device 210, and a data store 214 all in communication with one another via a network 216. The network 216 may include, without limitation, one or more local area networks (LANs) and/or wide area networks (WANs). Such networking environments are commonplace in offices, enterprise-wide computer networks, intranets, and the Internet. Accordingly, the network 216 is not further described herein.

The data store 214 may be configured to store information associated with various types of content, as more fully described below. It will be understood and appreciated by those of ordinary skill in the art that the information stored in the data store 214 may be configurable and may include any information relevant to online content. Further, though illustrated as a single, independent component, data store 214 may, in fact, be a plurality of data stores, for instance, a database cluster, portions of which may reside on a computing device associated with the price estimation engine 212, the user device 210, another external computing device (not shown), and/or any combination thereof.

Each of the price estimation engine 212 and the user device 210 shown in FIG. 2 may be any type of computing device, such as, for example, computing device 100 described above with reference to FIG. 1. By way of example only and not limitation, the advertising publisher engine 212 and/or the user device 210 may be a personal computer, desktop computer, laptop computer, handheld device, mobile handset, consumer electronic device, and the like. It should be noted, however, that the present invention is not limited to implementation on such computing devices, but may be implemented on any of a variety of different types of computing devices within the scope of the embodiments hereof.

As shown in FIG. 2, the price estimation engine 212 includes a receiving component 218, a table creating component 220, a calculating component 222, a search request receiving component 224, and a presenting component 226. In some embodiments, one or more of the illustrated components 218, 220, 222, 224, and 226 may be implemented as stand-alone applications. In other embodiments, one or more of the illustrated components 218, 220, 222, 224, and 226 may be integrated directly into the operating system of the price estimation engine 212 or the user device 210. In the instance of multiple servers, embodiments of the present invention contemplate providing a load balancer to federate incoming queries to the servers. It will be understood by those of ordinary skill in the art that the components 218, 220, 222, 224, and 226 illustrated in FIG. 2 are exemplary in nature and in number and should not be construed as limiting. Any number of components may be employed to achieve the desired functionality within the scope of the embodiments of the present invention. In some embodiments, the price estimation engine 212 further includes an advertising system 228. The advertising system 228, as the other illustrated components of the price estimation engine 212, may be implemented as a stand-alone application or may be integrated directly into the operating system of the price estimation engine 212.

The receiving component 218 is configured for receiving content, such as bids, associated with the keywords. More specifically, a bidding list may be received, where the bidding list contains the specific keywords of concern to the advertiser. Once received by the receiving component 218, the content may be stored, for instance, in association with data store 214, such that it is searchable to determine satisfaction of a user query, as more fully described below. Such received content may additionally be indexed, if desired.

The table creating component 220 is configured for creating one or more tables for use by the price estimating engine 212. More specifically, a table may be created to include various variables in order to estimate the price or bid amount of a keyword. For example, a price estimate table might include outputs such as impressions, clicks, cost per click, and monthly amount. Further, in embodiments of the invention, a table associated with the price estimation of two or more keywords will include a corrected value for impressions, where the corrected value is a value for impressions that is recalculated in consideration of other keywords, as will be further discussed below.

The calculating component 222 is configured to calculate the keywords that will be used in factoring the price estimate, and which keywords may be provided to an advertising system (e.g., advertising system 228 in FIG. 2). In embodiments of the present invention, the calculating component 222 matches the keywords that have common traffic, that is, keywords that contain similar terms. One skilled in the art will appreciate that a keyword, as referred to herein, may comprise one or more terms. In calculating matches, the calculating component 222 will determine the match type of the keywords. First, there may be no match. Further, there may be an exact match between a first and second keyword. If this is the case, then no overlapping of price estimation will occur.

Additionally, a first and second keyword may have a phrase match. One skilled in the art will appreciate that a phrase match, as used herein, is when one of the keywords includes terms that are a part of the second keyword. For example, a phrase match would occur if a first keyword was “Motorola phone” and a second keyword was “phone.” Because the first keyword contains the term “phone” these two keywords would be a phrase match.

When an advertiser bids on keywords, the type of match may be designated. That is, an advertiser may bid on a broad match of a keyword, or, alternatively, an exact match of the keyword. The broader the match desired by the advertiser typically results in a higher bid amount.

As a further example, a broad match may be determined by using the calculating component 222. A broad match, as used herein, occurs when every term of a first keyword is part of a second keyword. One skilled in the art will appreciate, however, that the terms may be present in the second keyword in a different order than they exist with the first keyword.

After a general price estimation procedure has been conducted for each keyword, an output table with additional information is added. One skilled in the art will appreciate that price estimation procedures are known in the art, and thus, any known method of such may be used. Generally, an output table from a price estimation includes data, such as impressions, clicks, cost per click, and monthly amount. In embodiments of the invention, additional data such as new impressions and number of terms in the keyword is included in the output table.

Another table may be populated that includes matching pairs of keywords. As described above, keywords, such as a first and second keyword, may match using various standards, for example, by phrase or broad match. The common traffic between the matching keywords is eliminated by finding all keywords that a first keyword matches. Then, for all those matching keywords, the keyword with the highest monetization value is determined. All matching rows of keywords are deleted from the populated table, except for the keyword with the highest monetization value. Using this populated table, a value of new impressions may be determined, and may be used as the value for impressions.

The search request receiving component 224 is configured for receiving a search request for which satisfying content is desired. By way of example, the search request may be received at a user interface as the result of user input. It will be understood and appreciated by those of ordinary skill in the art that multiple methods exist by which a user may input a search request. For instance, search requests may be input, by way of example only, utilizing a keyboard, joystick, trackball, touch-advertisement, or the like. Alternative user interfaces known in the software industry are contemplated by the invention. The search request is typically a user-initiated action or response that is received at a user interface, as discussed above. Examples of a request are a click, click-through, or selection by a user, e.g., human user or robotic user; however, it is understood and appreciated by one of ordinary skill in the art that a request may take any number of forms of indication at a web page. Further, it is contemplated by the present invention that a robotic user may be any non-human operator (i.e., an internet bot, web bot program, virus, robot, web crawler, web spidering program, or any software applications that run automated tasks over the Internet), which is an artificial agent that, by its actions, conveys a sense that it has intent or agency of its own. Even further, a human user is contemplated as being a human, but also, an entity (virtual or physical) acting under the present intent of a human operator.

The presenting component 226 is configured for presenting at least one of search results and information relating to the advertising based on the keywords extracted by the keyword extracting component 222. Typically such presentation will be by way of display in associations with a user interface. However, other forms of presentation, including audio presentation and audio/video presentation, are contemplated to be within the scope of embodiments hereof.

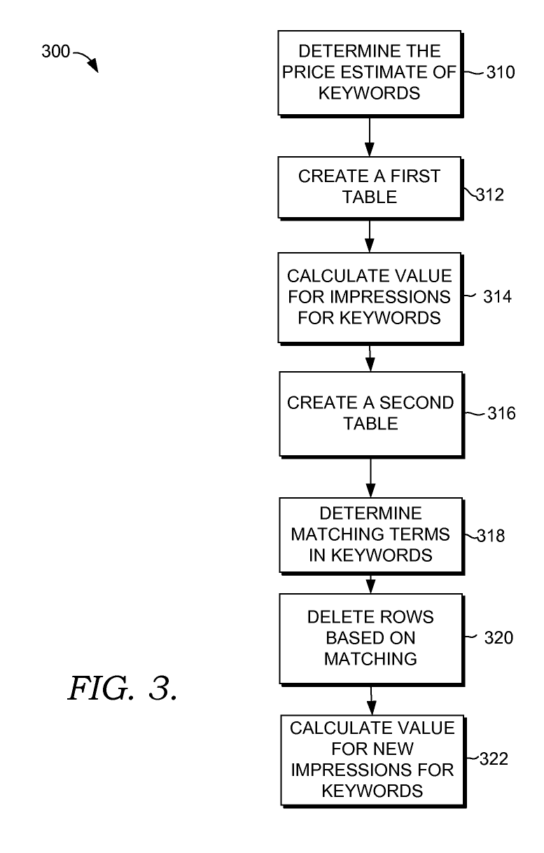

Turning now to FIG. 3, a flow diagram illustrating a method for providing a price estimate of two or more keywords is provided. Initially, as indicated at block 310, a price estimate of each keyword is performed. Such a price estimation may use any method known in the art, and will not be elaborated on herein. As discussed above, a keyword may include one or more terms.

Once a price estimation has been conducted, a first table is created, as shown at block 312 (e.g., by utilizing the table creating component 220 of FIG. 2). At block 314, the values for impressions for the keywords are calculated (e.g., by utilizing the calculating component 222 of FIG. 2), and these values are added to the table. At block 316, a second table is created, where the second table includes rows for a first and second keyword. Then, at block 318, matching terms in the keywords at determined. The rows that include a matching first and second keyword are deleted, at block 320. Finally, at block 322 a value for new impressions is created.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The invention claimed is:

1. One or more computer storage medium with computer-executable instructions embodied thereon for performing a method for providing a price estimate for two or more keywords, wherein the two or more keywords comprise the same match type, wherein each keyword comprises one or more terms, and wherein a first keyword comprises at least part of the terms of a second keyword, the method comprising:
determining the price estimate of each keyword;
creating a first table, wherein the first table includes a value for impressions for each keyword and a value for the number of terms in the keyword;
calculating a value for impressions of each keyword;
entering the value for impressions in the first table;
creating a second table that includes rows for a first and second keyword;
determining each first keyword that matches the second keyword;
deleting a row in the second table, wherein the row includes a matching first and second keyword; and
calculating a value for new impressions for each keyword, using the first and second table.

2. The one or more computer storage medium of claim 1, wherein the price estimate includes the impressions, clicks, cost per click, and monthly amount for each keyword.

3. The one or more computer storage medium of claim 1, wherein the first keyword and the second keyword have one term in common.

4. The one or more computer storage medium of claim 1, wherein each term in the first keyword is included in the second keyword.

5. The one or more computer storage medium of claim 1, wherein the keyword deleted includes the keyword with the lower monetization value.

6. The one or more computer storage medium of claim 1, wherein value of the impressions in the first table is the value of new impressions.

7. The one or more computer storage medium of claim 2, wherein the value of clicks is modified based on the value of the new impressions.

8. A computer system for providing a price estimate for an advertiser for two or more keywords, wherein each keyword comprises at least one terms, the computer system comprising:
a receiving component configured to receive a price estimate for two or more keywords, wherein the two or more keywords comprise one or more terms;
a table creating component configured to create a first table and a second table, wherein the first table includes a value for impressions for each keyword and a value for the number of terms in the keyword; and
a calculating component configured to calculate a value for new impressions based on the matching of the first and second keyword and the monetization value of each keyword.

9. The computer system of claim 8, further comprising an advertising system.

10. The computer system of claim 9, wherein the price estimate includes the impressions, clicks, cost per click, and monthly amount for each keyword.

11. The computer system of claim 8, wherein the first keyword and the second keyword have one term in common.

12. The computer system of claim 8, wherein each term in the first keyword is included in the second keyword.

13. The computer system of claim 8, wherein value of the impressions in the first table is the value of new impressions.

14. The computer system of claim 12, wherein the value of clicks is modified based on the value of the new impressions.

15. One or more computer storage medium with computer-executable instructions embodied thereon for performing a method for providing a price estimate for two or more keywords, wherein the two or more keywords comprise the same match type, wherein each keyword comprises one or more terms, and wherein a first keyword comprises at least part of the terms of a second keyword, the method comprising:
determining the price estimate of each keyword;
creating a first table, wherein the first table includes a value for impressions for each keyword and a value for the number of terms in the keyword;
calculating a value for impressions of each keyword;
entering the value for impressions in the first table;
creating a second table that includes rows for a first and second keyword;
determining each first keyword that matches the second keyword;
deleting a row in the second table, wherein the row includes a matching first and second keyword;
calculating a value for new impressions for each keyword; and
determining a new price estimate using the value of the new impressions.

16. The one or more computer storage medium of claim 15, wherein the price estimate includes the impressions, clicks, cost per click, and monthly amount for each keyword.

17. The one or more computer storage medium of claim 15, wherein the first keyword and the second keyword have one term in common.

18. The one or more computer storage medium of claim 15, wherein each term in the first keyword is included in the second keyword.

19. The one or more computer storage medium of claim 15, wherein value of the impressions in the first table is the value of new impressions.

20. The one or more computer storage medium of claim 15, wherein the value of clicks is modified based on the value of the new impressions.
